(19) United States
(12) Patent Application Publication
(10) Pub. No.: US 2026/0332548 A1
(43) Pub. Date: Oct. 22, 2026

(54) MESSAGING DEVICE AND METHOD FOR CONTROLLING MESSAGE TRANSMISSION BASED ON COMMUNICATION STATE

(71) Applicant: The Sunnai Marali Company Inc., Sacramento, CA (US)

(72) Inventors: Eric Kyungmo Hahn, Honolulu, HI (US); Geoffrey Sungjun Hahn, Honolulu, HI (US)

(21) Appl. No.: 19/648,991

(22) Filed: Apr. 15, 2026

Related U.S. Application Data
(60) Provisional application No. 63/789,962, filed on Apr. 16, 2025.

(51) Int. Cl. H04L 51/216; H04L 51/212

(52) U.S. Cl. CPC H04L 51/216; H04L 51/212

(57) ABSTRACT

A messaging device having a display and an input device controls message transmission between a sender and a recipient by presenting only an open circle and a filled circle as available message options for a communication. In response to receipt of the open circle, the messaging device arranges a contact associated with the communication in a new-message contact position ordered chronologically, blocks transmission of the open circle by the recipient while the contact remains in the new-message contact position, and permits transmission of the filled circle by the recipient as a reply to the open circle. After the filled circle is transmitted as the reply, the messaging device prevents the sender of the open circle from transmitting either the open circle or the filled circle from the new-message contact position.

### CROSS-REFERENCE TO RELATED APPLICATIONS

The present application claims the benefit of U.S. Provisional Application No. 63/789,962, filed Apr. 16, 2025, which is hereby incorporated by reference in its entirety.

### BACKGROUND

Electronic messaging platforms have become a common mechanism for personal and professional communication. Such platforms typically permit users to transmit messages, receive messages, and continue exchanges through a variety of available inputs and interface actions. In many implementations, users are presented with broad flexibility in how and when to respond within an ongoing conversation.

In some cases, established messaging approaches can permit conversational exchanges to continue in ways that are repetitive, fragmented, or unnecessarily prolonged. In some situations, known systems may encourage reciprocal responses, serial follow-up messages, or other interaction patterns that do not efficiently advance the communication. Such interaction patterns can contribute to user distraction, communication fatigue, and reduced clarity as conversations continue over time.

In addition, conventional messaging interfaces may provide limited control over how a communication progresses once a message has been transmitted or received. Known approaches may also provide limited support for guiding user interaction in a manner that reduces unnecessary back-and-forth exchanges while preserving the ability to communicate. Accordingly, a need exists for improved systems and techniques for managing electronic messaging interactions.

### SUMMARY

According to an aspect of the present disclosure, a messaging device comprises a display and an input device, the messaging device being configured to present only an open circle and a filled circle as available message options for a communication between a sender and a recipient, arrange a contact associated with the communication in a new-message contact position ordered chronologically in response to receipt of the open circle, block transmission of the open circle by the recipient while the contact remains in the new-message contact position, permit transmission of the filled circle by the recipient as a reply to the open circle, and prevent, after the filled circle is transmitted as the reply, the sender of the open circle from transmitting either the open circle or the filled circle from the new-message contact position.

In some embodiments, after the contact is moved from the new-message contact position to a default contact position ordered alphabetically, the messaging device permits transmission of the open circle by the recipient.

In some embodiments, after the recipient transmits the filled circle in reply to the open circle, the messaging device prevents the recipient from transmitting the open circle for a predetermined duration in both the new-message contact position and a default contact position.

In some embodiments, when the open circle to which the filled circle replied has become stale, the messaging device permits transmission of the open circle before expiration of the predetermined duration.

In some embodiments, when the filled circle is the only available reply message, the messaging device is configured to transmit the filled circle in response to a single tap, a double tap, or a long press entered through the input device.

In some embodiments, the filled circle is transmittable as a stand-alone statement without a preceding open circle.

In some embodiments, after transmission of the filled circle as the stand-alone statement, the messaging device prohibits transmission of another message for a predetermined duration.

In some embodiments, when the recipient transmits the filled circle in reply to the open circle, the messaging device generates the filled circle by filling the open circle displayed on the display.

In some embodiments, the messaging device saves only a most recent message comprising a last received message or a last sent message for the communication.

In some embodiments, the display is configured to present, in a list of chat rooms, one of three indications corresponding respectively to no received message, a received open circle, and a received filled circle.

According to an aspect of the present disclosure, a method of controlling message transmission between a sender and a recipient comprises presenting, on a messaging device, only an open circle and a filled circle as available message options, displaying a contact associated with the sender in a new-message contact position ordered chronologically after the recipient receives the open circle from the sender, blocking transmission of the open circle by the recipient while the contact remains in the new-message contact position, permitting the recipient to transmit the filled circle as a reply to the open circle, and permitting transmission of the open circle by the recipient after the contact is moved from the new-message contact position to a default contact position ordered alphabetically.

According to some embodiments, after the recipient transmits the filled circle in reply to the open circle, the sender of the open circle is prevented from transmitting either the open circle or the filled circle from the new-message contact position.

According to some embodiments, after the recipient receives the filled circle, the recipient is prevented from transmitting the open circle and the filled circle for a predetermined duration.

According to some embodiments, the predetermined duration is set by the sender, set by the recipient, or automatically determined based on a messaging frequency between the sender and the recipient.

According to some embodiments, a selected number of messages is kept displayed for the sender and the recipient and, when the selected number is exceeded, a message displayed first among the displayed messages is replaced with an immediately subsequent message.

According to some embodiments, replacing the message displayed first among the displayed messages with the immediately subsequent message occurs when the message displayed first among the displayed messages has not been viewed by an intended recipient.

According to an aspect of the present disclosure, a non-transitory computer-readable medium stores instructions that, when executed by a messaging device having a display and an input device, cause the messaging device to present only an open circle and a filled circle as available message options for a communication between a sender and a recipient, arrange a contact associated with the communication in a new-message contact position ordered chronologically in response to receipt of the open circle, block transmission of the open circle by the recipient while the contact remains in the new-message contact position, permit transmission of the filled circle by the recipient as a reply to the open circle, and prevent, after the filled circle is transmitted as the reply, the sender of the open circle from transmitting either the open circle or the filled circle from the new-message contact position.

In some embodiments, the instructions further cause the messaging device to display, in a list of chat rooms, one of three indications corresponding respectively to no received message, a received open circle, and a received filled circle.

In some embodiments, the instructions further cause the messaging device to save only a most recent message comprising a last received message or a last sent message for the communication.

In some embodiments, when the filled circle is a sole available reply message, the instructions cause the messaging device to transmit the filled circle in response to a single tap, a double tap, or a long press entered through the input device.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 illustrates a flow diagram according to one or more embodiments of methods of controlling message transmission of the present disclosure.

FIG. 2 illustrates a flow diagram according to one or more embodiments of methods of controlling message transmission of the present disclosure.

FIG. 3 illustrates a computer system according to one or more embodiments of systems for controlling message transmission of the present disclosure.

### DETAILED DESCRIPTION

The present disclosure is provided to illustrate general principles of a messaging device, a method of controlling message transmission, and a non-transitory computer-readable medium, and the particular arrangements, sequences, and examples described herein are illustrative and not limiting. In some embodiments, a display, an input device, available message options, an open circle, a filled circle, a sender, a recipient, a contact associated with the communication, a new-message contact position ordered chronologically, a default contact position ordered alphabetically, a predetermined duration, a list of chat rooms, a most recent message, a last received message, a last sent message, and other described features may be present, omitted, combined, rearranged, supplemented, or modified, unless incompatible, while remaining within the scope of the disclosure. Certain features may be optional and may not be required in all embodiments. Well-understood components, control logic, user interface operations, message handling operations, and implementation details are not necessarily described in detail so as not to obscure the present disclosure.

The present disclosure generally relates to electronic messaging and, more particularly, to user interactions within messaging applications on computing devices. In some embodiments, a messaging device having a display and an input device can control message transmission for a communication between a sender and a recipient by presenting only an open circle and a filled circle as available message options, by arranging a contact associated with the communication in a new-message contact position ordered chronologically or a default contact position ordered alphabetically, and by permitting, blocking, or preventing transmission in response to receipt of the open circle or the filled circle. Additional examples may involve a predetermined duration, a stand-alone statement, keeping displayed a selected number of messages, saving only a most recent message comprising a last received message or a last sent message for the communication, and presenting indications in a list of chat rooms, although any such features can vary from one embodiment to another.

In some embodiments, electronic messaging systems can permit conversational exchanges to continue in ways that are repetitive, fragmented, or unnecessarily prolonged. A user receiving a message may have broad freedom to transmit additional messages that repeat, redirect, or extend an exchange without regard to whether the communication has already served its immediate purpose. Over time, such unrestricted interaction patterns can contribute to distraction, communication fatigue, reduced clarity, and message histories that become cluttered or difficult to manage.

In some embodiments, existing messaging interfaces provide limited control over how a communication progresses once a message has been transmitted or received. The same message-entry options can remain available across different stages of an exchange without regard to whether the communication is awaiting an initial reply, has already received a reply, or is to temporarily conclude. As a result, known approaches may allow reciprocal prompts, repeated follow-up messages, or other message sequences that do not efficiently advance the communication.

In some embodiments, these issues can be addressed by configuring a messaging device to control message transmission according to a current communication state associated with a sender, a recipient, and a contact position within a messaging interface. Rather than permitting unrestricted message generation at all times, the messaging device can present a reduced set of available message options and can selectively permit, block, or prevent transmission according to the current communication state.

In some embodiments, the messaging device can present an open circle and a filled circle as available message options for a communication. In response to receipt of the open circle, the messaging device can arrange a contact associated with the communication in a new-message contact position ordered chronologically, can block transmission of the open circle by the recipient while the contact remains in the new-message contact position, and can permit transmission of the filled circle by the recipient as a reply to the open circle.

In some embodiments, after the filled circle is transmitted as the reply, the messaging device can prevent the sender of the open circle from transmitting either the open circle or the filled circle from the new-message contact position. In some embodiments, the messaging device can permit transmission of the open circle after the contact is moved from the new-message contact position to a default contact position ordered alphabetically, after expiration of a predetermined duration, or after a message has become stale. In this manner, the messaging device can control how a communication progresses by changing available user inputs, transmission permissions, and contact ordering behavior according to the current communication state.

In some embodiments, the disclosed arrangements can improve operation of electronic messaging systems by reducing unnecessary message generation, limiting repeated transmissions from interface states in which such transmissions are not permitted, and constraining message progression to a defined sequence enforced by the messaging device. Additional examples may involve transmitting a sole available reply message in response to a simplified user input, keeping displayed a selected number of messages, saving only a most recent message comprising a last received message or a last sent message for the communication, and presenting indications in a list of chat rooms that reflect a current message status.

Accordingly, the disclosed embodiments can provide improved systems and techniques for managing electronic messaging interactions on computing devices. These and other aspects of the disclosure will now be described with regard to certain examples and embodiments, which are intended to illustrate and not to limit the disclosure.

A messaging device comprises a display and an input device. The messaging device presents only an open circle and a filled circle as available message options for a communication between a sender and a recipient. In response to receipt of the open circle, the messaging device arranges a contact associated with the communication in a new-message contact position ordered chronologically. While the contact remains in the new-message contact position, the messaging device blocks transmission of the open circle by the recipient and permits transmission of the filled circle by the recipient as a reply to the open circle. After the filled circle is transmitted as the reply, the messaging device prevents the sender of the open circle from transmitting either the open circle or the filled circle from the new-message contact position.

A method of controlling message transmission between a sender and a recipient comprises presenting, on a messaging device, only an open circle and a filled circle as available message options, displaying a contact associated with the sender in a new-message contact position ordered chronologically after the recipient receives the open circle from the sender, blocking transmission of the open circle by the recipient while the contact remains in the new-message contact position, permitting the recipient to transmit the filled circle as a reply to the open circle, and permitting transmission of the open circle by the recipient after the contact is moved from the new-message contact position to a default contact position ordered alphabetically. A non-transitory computer-readable medium stores instructions that, when executed by a messaging device having a display and an input device, cause the messaging device to present only an open circle and a filled circle as available message options for a communication between a sender and a recipient, arrange a contact associated with the communication in a new-message contact position ordered chronologically in response to receipt of the open circle, block transmission of the open circle by the recipient while the contact remains in the new-message contact position, permit transmission of the filled circle by the recipient as a reply to the open circle, and prevent, after the filled circle is transmitted as the reply, the sender of the open circle from transmitting either the open circle or the filled circle from the new-message contact position.

In some embodiments, after the contact is moved from the new-message contact position to a default contact position ordered alphabetically, the messaging device permits transmission of the open circle by the recipient. In some embodiments, after the recipient transmits the filled circle in reply to the open circle, the messaging device prevents the recipient from transmitting the open circle for a predetermined duration in both the new-message contact position and a default contact position. In some embodiments, after the recipient receives the filled circle, the recipient is prevented from transmitting the open circle and the filled circle for the predetermined duration. The predetermined duration may be set by the sender, set by the recipient, or automatically determined based on a messaging frequency between the sender and the recipient. In some embodiments, the predetermined duration is 5 minutes, 1 hour, 3 hours, or 24 hours. In some embodiments, when the open circle to which the filled circle replied has become stale, the messaging device permits transmission of the open circle before expiration of the predetermined duration, including when the open circle was sent over 48 hours earlier.

In some embodiments, when the filled circle is the only available reply message, the messaging device is configured to transmit the filled circle in response to a single tap, a double tap, or a long press entered through the input device. In some embodiments, the filled circle is transmittable as a stand-alone statement without a preceding open circle. In some embodiments, after transmission of the filled circle as the stand-alone statement, the messaging device prohibits transmission of another message for the predetermined duration. In some embodiments, when the recipient transmits the filled circle in reply to the open circle, the messaging device generates the filled circle by filling the open circle displayed on the display. In other embodiments, the open circle displayed on the display and the filled circle transmitted in reply are displayed as separate messages.

In some embodiments, the messaging device saves only a most recent message comprising a last received message or a last sent message for the communication. In some embodiments, the method includes keeping displayed a selected number of messages for the sender and the recipient and, when the selected number is exceeded, replacing a message displayed first among the displayed messages with an immediately subsequent message. The selected number of messages may be one per side or one total. In some embodiments, replacing the message displayed first among the displayed messages with the immediately subsequent message occurs when the message displayed first among the displayed messages has not been viewed by an intended recipient.

In some embodiments, the display is configured to present, in a list of chat rooms, one of three indications corresponding respectively to no received message, a received open circle, and a received filled circle. In some embodiments, the list of chat rooms reflects a current message status for respective communications while the contact associated with the communication is selectively presented in the new-message contact position ordered chronologically or the default contact position ordered alphabetically.

### Preventing Answering Open Circle With Open Circle

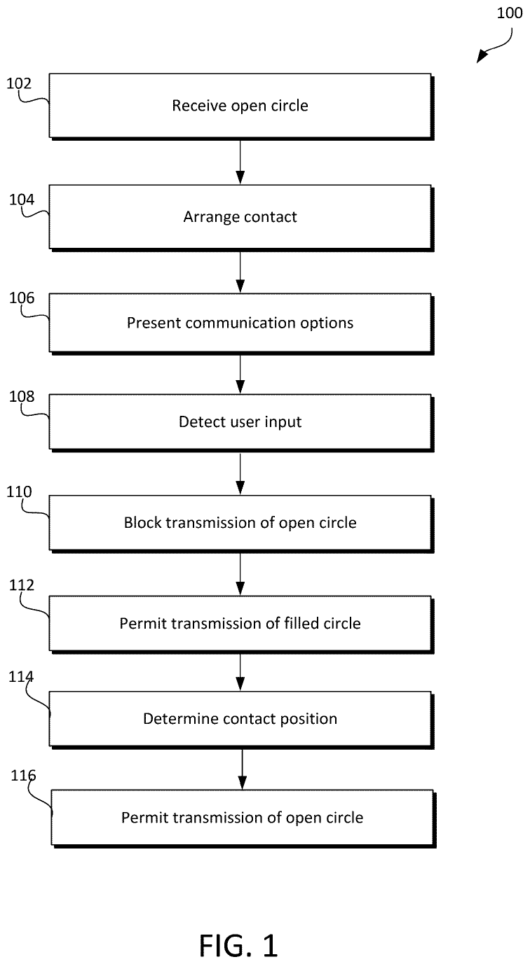

FIG. 1 depicts a flow diagram of a method 100 for controlling message transmission in an electronic messaging application by restricting available message options according to a current communication state. The method 100 starts at step 102 when a messaging device receives, from a sender, an open circle for a communication with a recipient. In some embodiments, the messaging device is a smartphone executing a messaging application and having a display and an input device. In some embodiments, upon receipt of the open circle, the messaging device displays the communication and arranges a contact associated with the communication in a new-message contact position ordered chronologically.

At step 104, the messaging device determines that the communication is in a new-message state associated with the received open circle. In some embodiments, while the contact remains in the new-message contact position, the messaging device presents only an open circle and a filled circle as available message options for the communication. The messaging device may further associate the open circle with a prompt requiring a response and may associate the filled circle with a reply or statement. In some embodiments, the new-message state is maintained until the contact is moved from the new-message contact position to a default contact position ordered alphabetically, until a predetermined duration expires, or until the received open circle becomes stale.

At step 106, the messaging device detects a user input by the recipient while the communication remains in the new-message state. In some embodiments, the user input is entered through a touchscreen, keyboard, button, gesture input, or another input device of the messaging device. In some embodiments, the messaging device evaluates the user input to determine whether the recipient is attempting to transmit the open circle, transmit the filled circle, ignore the communication, or initiate another permitted interface action.

At step 108, in response to determining that the recipient is attempting to transmit the open circle while the contact remains in the new-message contact position, the messaging device blocks transmission of the open circle. In some embodiments, the messaging device suppresses creation of the message, prevents transmission over a network interface, and maintains the communication in the new-message state. Transmission control may be enforced by suppressing message creation, disabling user interface elements, blocking network transmission at a network interface, or rejecting a transmission request at a messaging service based on the current communication state. In this manner, the messaging device prevents the recipient from answering a question with a question while the communication remains in the new-message contact position.

At step 110, in response to determining that the recipient is attempting to transmit the filled circle while the contact remains in the new-message contact position, the messaging device permits transmission of the filled circle as a reply to the open circle. In some embodiments, the filled circle is transmitted in response to a single tap, a double tap, a long press, or another designated input. In some embodiments, the messaging device displays the transmitted filled circle in the communication and updates a chat-room list or other interface region to reflect a received or transmitted message status associated with the communication.

At step 112, in some embodiments, the messaging device detects a user action that moves the contact associated with the communication from the new-message contact position to a default contact position ordered alphabetically. In response to the contact being moved to the default contact position, the messaging device may modify the communication state so that transmission of the open circle is permitted. In some embodiments, such state change allows a subsequent open circle to be transmitted even though the previously received open circle was not answered with an open circle from the new-message contact position.

At step 114, in some embodiments, the messaging device determines that the received open circle has become stale. The messaging device may determine staleness based on expiration of a threshold time period, such as a period measured from a transmission time or receipt time of the open circle. In response to determining that the open circle has become stale, the messaging device may permit transmission of the open circle notwithstanding a prior restriction associated with the new-message state.

At step 116, the messaging device maintains, updates, or displays the communication according to the resulting state. In some embodiments, the messaging device keeps displayed a selected number of messages for the communication or saves only a most recent message comprising a last received message or a last sent message for the communication. FIG. 1 thus illustrates an example in which the messaging device constrains message progression by preventing transmission of the open circle from the new-message contact position while permitting transmission of the filled circle as the reply.

### End of Message/Timeout Behavior

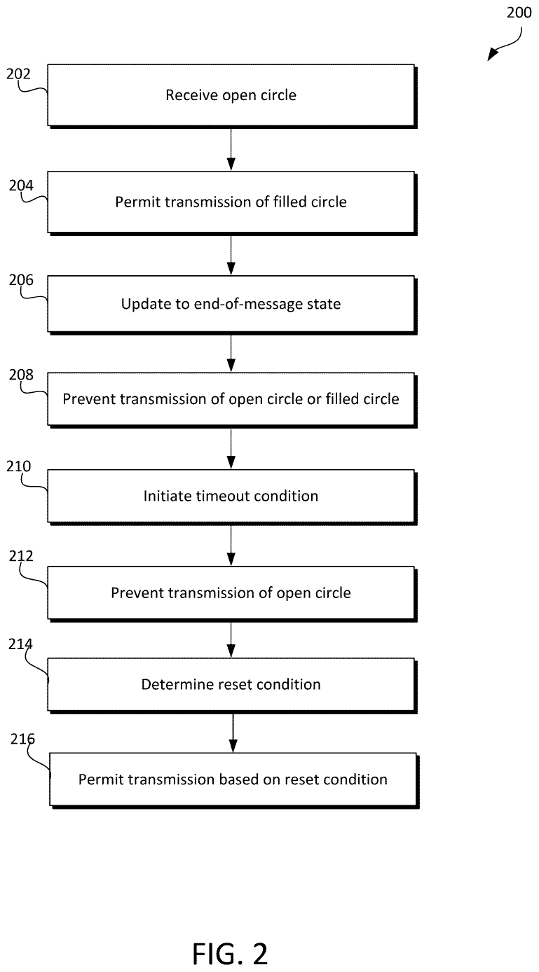

FIG. 2 depicts a flow diagram of a method 200 for controlling message transmission after a filled circle is transmitted in reply to an open circle. The method 200 starts at step 202 when a sender transmits an open circle to a recipient and, while the communication is associated with a new-message contact position, the recipient transmits a filled circle as the reply. In some embodiments, the messaging device displays the open circle and the filled circle in the communication as separate messages. In other embodiments, the messaging device generates the filled circle by filling the previously displayed open circle.

At step 204, in response to transmission of the filled circle as the reply, the messaging device updates the communication state to an end-of-message state associated with the communication. In some embodiments, the end-of-message state corresponds to a state in which the originating open circle has been answered and the communication is to be temporarily concluded from the new-message contact position. The messaging device may update a displayed chat-room list, contact ordering, message indicator, or other interface element to reflect the updated state.

At step 206, while the communication remains in the end-of-message state and the contact remains in the new-message contact position, the messaging device prevents the sender of the originating open circle from transmitting either the open circle or the filled circle from the new-message contact position. In some embodiments, the messaging device disables one or more input controls, suppresses message creation, or otherwise prevents further message transmission from that interface state. In this manner, receipt of the filled circle can operate as an end of message for the originating sender while the communication remains in the new-message contact position.

At step 208, in some embodiments, the messaging device applies a predetermined duration associated with a timeout condition after the filled circle is transmitted in reply to the open circle. In some embodiments, the messaging device prevents the recipient who transmitted the filled circle from subsequently transmitting the open circle for the predetermined duration in both the new-message contact position and the default contact position. The predetermined duration may be fixed, user-configurable, or automatically determined based on one or more characteristics of the communication.

At step 210, in some embodiments, the messaging device determines whether a reset condition has occurred. The reset condition may include movement of the contact from the new-message contact position to the default contact position, expiration of the predetermined duration, or determination that the originating open circle has become stale. In response to the reset condition, the messaging device can permit a new transmission of the open circle, the filled circle, or both according to the updated communication state.

At step 212, in some embodiments, the messaging device permits transmission of the filled circle as a stand-alone statement without a preceding open circle. After transmission of the filled circle as the stand-alone statement, the messaging device may prohibit transmission of another message for the predetermined duration. In some embodiments, this operation similarly causes the messaging device to treat the communication as concluded unless and until a reset condition is satisfied.

At step 214, the messaging device updates storage or presentation of the communication according to the resulting state. In some embodiments, the messaging device saves only a most recent message comprising a last received message or a last sent message for the communication. In some embodiments, the display presents, in a list of chat rooms, one of multiple indications corresponding respectively to no received message, a received open circle, and a received filled circle. FIG. 2 thus illustrates an example in which the messaging device enforces an end-of-message state and a timeout condition following transmission of the filled circle.

### Definitions

As used herein, the term “open circle” refers to a message option that is representable in a circular unfilled form and that is selectable or transmittable within the communication states defined for a communication between a sender and a recipient. The open circle can serve as an initial message in a communication, can trigger arrangement of a contact associated with the communication in a new-message contact position ordered chronologically, and can be subject to transmission permissions or restrictions that depend on the current communication state.

As used herein, the term “filled circle” refers to a message option that is representable in a circular filled form and that is selectable or transmittable within the communication states defined for a communication between a sender and a recipient. The filled circle can be transmittable as a reply to the open circle or as a stand-alone statement, and transmission of the filled circle can be permitted, restricted, or prevented according to the current communication state.

As used herein, the term “available message options” refers to the set of message choices that the messaging device currently makes available for user selection or transmission for a particular communication at a particular time. The available message options can vary according to the communication state and, in some implementations, can be limited to the open circle and the filled circle.

As used herein, the term “contact associated with the communication” refers to a displayed contact entry, conversation entry, or other interface item corresponding to the communication between the sender and the recipient. The contact associated with the communication can be moved, arranged, or displayed in different positions within a messaging interface according to message receipt, message status, or other communication-state conditions.

As used herein, the term “new-message contact position” refers to a position of the contact associated with the communication within a messaging interface that is used for communications having a newly received message or a current message status designated for chronological ordering. The new-message contact position can be ordered chronologically relative to other contacts associated with respective communications.

As used herein, the term “ordered chronologically” refers to an arrangement based on time-related sequence. When a contact associated with the communication is ordered chronologically, its position is determined according to timing of message activity, including receipt or other occurrence of a message-related event, relative to other contacts.

As used herein, the term “default contact position” refers to a position of the contact associated with the communication within a messaging interface when the communication is not being presented in the new-message contact position. The default contact position can correspond to a baseline or typical arrangement of contacts and can be ordered alphabetically relative to other contacts.

As used herein, the term “ordered alphabetically” refers to an arrangement based on alphabetical sequence of text associated with respective contacts, chat rooms, or communications. When a contact associated with the communication is ordered alphabetically, its position is determined according to that alphabetical sequence rather than according to chronological message activity.

As used herein, the term “predetermined duration” refers to a duration established in advance for controlling when a message can be transmitted, replied to, blocked, or prevented. The predetermined duration can be fixed, user-set, recipient-set, sender-set, or automatically determined, including based on a messaging frequency between the sender and the recipient.

As used herein, the term “stale” refers to a state of a message, including an open circle, in which the message is treated by the messaging device as no longer governing a current restriction, timeout condition, or reply condition for the communication. A message can become stale before expiration of a predetermined duration in accordance with criteria applied by the messaging device.

As used herein, the term “stand-alone statement” refers to a transmitted message that is not contingent on being preceded by another message in the communication sequence. A filled circle transmitted as a stand-alone statement, as a result, constitutes a complete transmitted statement in the absence of a preceding open circle.

As used herein, the term “list of chat rooms” refers to an interface listing that presents multiple chat rooms, conversations, or communication entries. The list of chat rooms can present for each chat room a corresponding indication of message status, including whether no message has been received, an open circle has been received, or a filled circle has been received.

As used herein, the term “indications” refers to displayed states, symbols, markers, or other presented outputs that convey information regarding a message condition or communication status. In the list of chat rooms, the indications can respectively correspond to no received message, a received open circle, and a received filled circle.

As used herein, the term “messaging frequency” refers to a measure of how often messages are exchanged between the sender and the recipient over time. The messaging frequency can be used by the messaging device to automatically determine a predetermined duration.

As used herein, the term “selected number of messages” refers to a specified quantity of messages that are to remain displayed for the sender and the recipient. When the selected number of messages is exceeded, the messaging device can replace a message displayed first among the displayed messages with an immediately subsequent message.

### Other Embodiments

In some embodiments, messages are binary in nature such that a sending user (sender) can send only one of two messages. For example, the sender can send an open circle or a filled circle (or dot). The receiving user (recipient) can reply to an open circle only by sending a filled circle, and cannot reply at all to a filled circle (e.g., for a predetermined duration, 5 minutes, 1 hour, 24 hours, etc., also referred to as a timeout). For example, upon receiving an open circle, the recipient cannot send an open circle back to the sender for a predetermined duration. As another example, upon receiving a filled circle, the recipient cannot send a filled circle or an open circle back to the sender for a predetermined duration. As another example, upon receiving an open circle, the recipient can send a filled circle back to the sender even before a predetermined duration has elapsed. In other embodiments, binary options other than open circles and filled circles are used. In other embodiments, more than two options are available.

In the example above, since there is only one or zero option for the reply message, a simplified user input such as a single tap, double tap, long press, etc. performed on the screen or entered via the input device of the messaging device (e.g., smartphone) may send the reply message (or nothing may happen if there is no available reply message that can be sent).

The predetermined duration can be set by the sender and/or the recipient, or can be automatically determined based on the messaging frequency between the sender and the recipient.

In some embodiments, each message between the sender and the recipient is displayed on the screen, and if there are more messages than can be displayed in a single screen, the newest messages may be displayed and a scroll bar may allow older messages not displayed in the current screen to be displayed by allowing the user to scroll up through the messages. In other embodiments, only a specific number of messages are kept displayed on the screen, and when that number is exceeded, the oldest message would be replaced by the message immediately subsequent to that message. In some embodiments, the number is 1 per side (e.g., sender sends an open circle, which would be displayed, and recipient responds with a filled circle, and both messages would remain displayed, and when, at a later time, sender or recipient sends initiates a conversation by sending an open circle or a filled circle, it would replace the message previously sent by that sender or recipient. In other embodiments, the number is 1 total, (e.g., sender sends an open circle, which would be displayed, and recipient responds with a filled circle, which would replace the sender's open circle, and when, at a later time, sender or recipient sends initiates a conversation by sending an open circle or a filled circle, it would replace the message previously sent by the recipient).

In some embodiments, when recipient sends a filled circle in response to sender's open circle, the filled circle is generated by filing the open circle displayed on the screen. In other embodiments, the open circle sent by sender and the filled circle sent by the recipient in response to the open circle are displayed as separate messages.

In some embodiments, the messaging pattern can be visualized as progressing from start, an open circle, a filled circle, and end. If a message communication is started with an open circle, it can progress to a filled circle before ending. If a message communication is started with a filled circle, it has just ended, and no other messages can be sent, for the duration of the timeout period. For example, an open circle cannot be answered with an open circle, and a closed circle cannot be answered with anything (closed circle or open circle).

In some embodiments, sender may be timed out or restricted from sending additional messages after the initial message. For example, for starting a message communication, the sender may be presented with two options (open circle and filled circle). After sender sends an open circle, the sender may not be allowed to send another message for a timeout period after that initial transmission, or for a timeout period after recipient replies to the initial message from sender (e.g., the open circle). After sender sends an filled circle, the sender may not be allowed to send another message for a timeout period after that initial transmission. After the timeout period has elapsed, either user may be able to initiate a new message communication. In other embodiments, sender is not restricted from sending another message. Said another message may replace sender's prior message, or may be displayed in addition to sender's prior message.

In some embodiments, only the most recent message from a user is displayed the other user. For example, if sender sends 50 messages while recipient is away from recipient's phone, when recipient returns, he or she may only see 1 message from sender, which may be the latest message from sender. In some embodiments, subsequent messages replace the prior messages only if recipient has not viewed the prior messages. For example, if recipient received and read a filed circle from sender, a subsequent filled circle or open circle from sender (e.g., after a timeout period has passed) may not replace the previous filled circle. However, if the initial filled circle was unread by recipient, sender's subsequent open circle or filled circle may replace the initial filled circle. In some embodiments, whether a message has been read or not is indicated using a read receipt.

In some embodiments, sender is not timed out or locked from sending additional messages unless and until a message has been read by the recipient. For example, before recipient has read sender's message, sender may be able to send another message to replace sender's previous message. In other embodiments, sender is timed out (or locked) from sending additional messages even before a message has been read by the recipient. For example, before recipient has read sender's message, sender may still be prevented from sending another message to recipient.

In the list of chat rooms, each chat room may provide one of three indications: (1) no message has been received from the sender associated with the chat room, (2) a filled circle has been received from the sender associated with the chat room, or (3) an open circle has been received from the sender associated with the chat room.

In some embodiments, the input device of the messaging device is configured to detect one or more touch inputs associated with a communication, a contact associated with the communication, a message option, or a displayed message. The touch inputs can include, for example, a single tap, a double tap, a long press, a swipe left, a swipe right, a drag, or another gesture. In some embodiments, the messaging device maps a detected touch input to a corresponding communication action according to a current communication state, such that the same gesture can cause different actions in different states of the communication.

In some embodiments, a single tap can operate as a shortcut for transmitting a message option that is currently permitted by the messaging device. For example, when a filled circle is the sole available reply message for a communication, a single tap on the contact, a single tap on the filled circle, or a single tap on a corresponding control can cause the messaging device to transmit the filled circle as a reply. In some embodiments, when an open circle is permitted in a current communication state, the single tap can instead cause transmission of the open circle. In other embodiments, the messaging device may first display the currently available message options and then receive a subsequent tap selecting one of the available options.

In some embodiments, a double tap can correspond to a second shortcut action associated with the communication. For example, a double tap can cause the messaging device to transmit a permitted message option, to mark a communication as read, to acknowledge the communication without transmitting an additional message, to move the contact from a new-message contact position to a default contact position, or to otherwise update the communication state. In some embodiments, the double tap can cause the messaging device to remove the contact from a chronologically ordered pending region and return the contact to a normal position within an alphabetically ordered contact list. In this manner, the double tap can serve as a rapid state-transition input without requiring the user to navigate through multiple interface screens.

In some embodiments, a long press can cause the messaging device to present a contextual menu or another control interface associated with the communication. The contextual menu can identify one or more actions that are available in the current communication state, such as transmitting an open circle, transmitting a filled circle, moving the contact to a normal position, maintaining the contact in a new-message position, marking the communication as read, muting the communication, pinning the communication, or invoking another message-handling action. In some embodiments, when only one message option is available in the current communication state, the long press can cause the messaging device to transmit that sole available message option without presenting the full menu.

In some embodiments, a swipe left on the contact can be used as a shortcut for a first contact-management action. For example, the swipe left can cause the messaging device to move the contact from the new-message contact position to the default contact position, to dismiss the contact from a pending-message region, to mark the communication as read, to collapse one or more displayed messages, or to trigger another state change associated with the communication. In some embodiments, the swipe left can thereby return the contact to a normal position within the messaging interface without requiring transmission of a reply message.

In some embodiments, a swipe right on the contact can be used as a shortcut for a second action different from the action associated with the swipe left. For example, the swipe right can cause the messaging device to initiate transmission of an open circle when permitted, initiate transmission of a filled circle when permitted, display a reduced set of available reply options, elevate the contact within a list, maintain the contact in a new-message state, or invoke a confirmation control before transmission is performed. In some embodiments, the swipe right can operate as a gesture-based reply input that allows a user to respond to a communication directly from a list view without opening a full chat view.

In some embodiments, gesture-to-action mappings can vary based on the current communication state. For example, a single tap or swipe right may cause transmission of a filled circle when the communication is in a new-message state and a filled circle is the only permitted reply, whereas the same input may cause transmission of an open circle when the contact has already been moved to a default contact position or when a stale-message condition has been satisfied. Similarly, a double tap or swipe left may cause the messaging device to move the contact to a normal position in one state, while causing the messaging device to mark the communication as read or dismissed in another state. Accordingly, the messaging device can interpret touch inputs in a state-aware manner rather than assigning a fixed meaning to each gesture independent of context.

In some embodiments, the messaging device can distinguish between gestures performed on different interface elements. For example, a gesture performed directly on the contact in a contact list may cause a contact-ordering action, whereas a gesture performed on a displayed message option may cause a transmission action, and a gesture performed within an open chat view may cause a message-history action. In some embodiments, the messaging device can also distinguish between gestures based on gesture duration, gesture direction, gesture distance, gesture location, number of taps, or whether the input is performed on a contact image, contact name, message icon, or another displayed region.

In some embodiments, one or more of the gesture-based shortcuts can reduce the number of interface operations needed to perform a communication action while preserving state-based control over which actions are permitted. Thus, a user may be able to respond, dismiss, reorder, or otherwise manage a communication through a single tap, double tap, long press, swipe left, or swipe right, while the messaging device continues to enforce restrictions associated with a new-message state, an end-of-message state, a timeout condition, a stale-message condition, or another communication state. In this manner, the messaging device can improve interaction efficiency while maintaining controlled progression of the communication.

In some embodiments, the messaging device maintains, for each communication between a sender and a recipient, a communication record that includes one or more communication-state values used to control transmission permissions and user interface presentation. The communication record can be stored locally on the messaging device, stored remotely at a messaging service, or stored in a synchronized manner at both. In some embodiments, the communication record includes a last message type value indicating whether a most recent message is an open circle, a filled circle, or no message, a last message timestamp value, a viewed-status value indicating whether the most recent message has been viewed by an intended recipient, a contact-position value indicating whether a contact associated with the communication is arranged in a new-message contact position ordered chronologically or a default contact position ordered alphabetically, and a timeout value indicating whether a predetermined duration is currently active.

In some embodiments, the messaging device determines a current communication state for a communication based on one or more values of the communication record. For example, the current communication state can be an initial state in which no message has been received, a new-message state in which an open circle has been received and the contact is arranged in the new-message contact position, an end-of-message state in which a filled circle has been transmitted as a reply to an open circle, a timeout state in which at least one user is restricted from transmitting one or more message options, a stale-message state in which an earlier message is treated as stale for purposes of a restriction, or a default state in which the contact is arranged in the default contact position. In some embodiments, the messaging device updates the current communication state in response to message receipt, message transmission, message viewing, movement of the contact within the messaging interface, expiration of a predetermined duration, or determination that a message has become stale.

In some embodiments, the messaging device enforces message-option availability based on the current communication state by determining an available message options set for the communication and by enabling, disabling, or hiding one or more input controls corresponding to the available message options set. In some embodiments, while the communication is in a new-message state, the messaging device presents only an open circle and a filled circle as available message options and restricts transmission such that the recipient cannot transmit an open circle from the new-message contact position while a filled circle is permitted as a reply to the open circle. In some embodiments, the messaging device additionally restricts transmission such that the sender of the open circle is prevented from transmitting either the open circle or the filled circle from the new-message contact position after the filled circle is transmitted as the reply.

In some embodiments, the messaging device applies different restriction policies to different users and to different message options. For example, a first restriction policy can prevent a recipient who received an open circle from transmitting an open circle while the contact remains in the new-message contact position. A second restriction policy can prevent a sender of the open circle from transmitting either the open circle or the filled circle from the new-message contact position after the filled circle is transmitted as the reply. A third restriction policy can prevent a recipient who transmitted the filled circle as the reply from transmitting an open circle for a predetermined duration in both the new-message contact position and the default contact position. A fourth restriction policy can prevent a recipient who received a filled circle from transmitting the open circle and the filled circle for the predetermined duration. In some embodiments, any one or more of these restriction policies can be applied, omitted, combined, or modified for a given implementation.

In some embodiments, the messaging device initiates the predetermined duration based on a timer start condition. The timer start condition can be a transmission time of a message, a receipt time of a message, a view time of a message, a time at which a filled circle is transmitted as a reply, or a time at which a contact is moved to a default contact position. In some embodiments, the messaging device stores a timeout expiration time value and determines whether a restricted user is permitted to transmit a message option by comparing a current time to the timeout expiration time value.

In some embodiments, the messaging device automatically determines the predetermined duration based on a messaging frequency between the sender and the recipient. In some embodiments, messaging frequency is determined based on a count of messages exchanged within a time window, an inter-message time distribution, an average number of messages per day, or another measure. In some embodiments, the messaging device selects a predetermined duration from a set of candidate durations based on the messaging frequency. In other embodiments, the messaging device computes the predetermined duration using a function of the messaging frequency.

In some embodiments, the messaging device determines that an open circle has become stale based on satisfaction of one or more stale criteria. The stale criteria can include expiration of a staleness threshold time period measured from a send time, receipt time, or view time of the open circle, movement of the contact to the default contact position, transmission of a subsequent message that supersedes the open circle, or a user action that dismisses or archives the communication. In some embodiments, when the open circle becomes stale, the messaging device permits transmission of a message option that was previously restricted, including permitting transmission of an open circle before expiration of a predetermined duration.

In some embodiments, a reset condition can include expiration of the predetermined duration, determination that an open circle has become stale, movement of the contact from the new-message contact position to the default contact position, or another state transition specified by the messaging device. In response to a reset condition, the messaging device can update the communication record to indicate that a previously restricted message option is permitted, can update the available message options set, and can update an indication displayed in a list of chat rooms.

In some embodiments, the messaging device controls arrangement of contacts within the messaging interface using one or more ordered regions. For example, a first region can include contacts arranged in the new-message contact position ordered chronologically based on time of receipt of a most recent message, and a second region can include contacts arranged in the default contact position ordered alphabetically. In some embodiments, the messaging device automatically moves a contact into the new-message contact position in response to receipt of an open circle. In some embodiments, the messaging device moves the contact into the default contact position in response to a user action, expiration of a predetermined duration, or determination of staleness. In some embodiments, when a contact is pinned, favorited, or otherwise assigned a priority, the messaging device can maintain the contact at a designated location while still applying the communication-state restrictions described herein.

In some embodiments, the messaging device distinguishes between actions performed in a list view and actions performed in a chat view. In some embodiments, the messaging device interprets a gesture performed on a contact displayed in a list of chat rooms as a contact-management instruction, such as moving the contact to the default contact position, dismissing the contact from a pending region, or presenting a contextual control. In some embodiments, the messaging device interprets a gesture performed on a displayed message option or within a chat view as a message-transmission instruction, such as transmitting a permitted open circle or transmitting a permitted filled circle.

In some embodiments, the messaging device implements shortcut gesture mappings for transmitting a sole available reply message. For example, when a filled circle is the only available reply message in a new-message state, the messaging device can transmit the filled circle in response to a single tap, a double tap, a long press, a swipe right, or another designated input. In some embodiments, when no reply message option is permitted in a current communication state, the messaging device disregards a detected gesture, maintains the current communication state, and optionally provides an output indicating that transmission is not permitted.

In some embodiments, the messaging device provides shortcut gesture mappings for state changes that do not include transmitting a message. For example, a swipe left, double tap, or long press can cause the messaging device to move a contact from the new-message contact position to the default contact position, to mark a communication as read, to present a contextual menu, to mute the communication, to pin the communication, or to dismiss the communication from a pending region. In some embodiments, such gesture-based state changes are permitted even when message transmission is restricted, such that a user can manage contact ordering and message status without transmitting a disallowed message option.

In some embodiments, the filled circle is transmittable as a stand-alone statement without a preceding open circle and can be treated as a complete communication action that places the communication into an end-of-message state. In some embodiments, after transmission of the filled circle as the stand-alone statement, the messaging device prohibits transmission of another message for the predetermined duration. In some embodiments, the predetermined duration applied after the stand-alone statement differs from a predetermined duration applied after the filled circle is transmitted as a reply to an open circle.

In some embodiments, the messaging device controls how message content is displayed or stored by limiting retention of message history. In some embodiments, the messaging device saves only a most recent message comprising a last received message or a last sent message for the communication. In other embodiments, the messaging device keeps displayed a selected number of messages and, when the selected number is exceeded, replaces a message displayed first among the displayed messages with an immediately subsequent message. In some embodiments, replacement occurs only when a message displayed first among the displayed messages has not been viewed by an intended recipient. In some embodiments, replacement is performed for display only while a larger message history is stored in memory, and in other embodiments, replacement includes deleting or omitting storage of replaced messages.

In some embodiments, the messaging device maintains a viewed-status value for a most recent message and updates the viewed-status value based on one or more view events. A view event can be a chat view being opened, a message being presented on the display for a threshold duration, a user interaction with the message, or receipt of a read receipt. In some embodiments, the messaging device applies different replacement rules, different contact-ordering rules, or different transmission restrictions depending on whether a most recent message has been viewed.

In some embodiments, the display presents, in a list of chat rooms, one of three indications corresponding respectively to no received message, a received open circle, and a received filled circle. In some embodiments, each indication includes a symbol corresponding to the most recent message type, a color, a badge, a text label, or another visual output. In some embodiments, the messaging device updates the indication based on one or more state changes including message receipt, message transmission, message viewing, expiration of a predetermined duration, or movement of the contact between the new-message contact position and the default contact position.

In some embodiments, transmission restrictions are enforced at one or more control points. For example, the messaging device can enforce a restriction by preventing presentation of a restricted message option, by disabling a user interface control corresponding to the restricted message option, by suppressing creation of a message object in response to a user input, by blocking network transmission of a message over a network interface, or by rejecting a message at a messaging service that validates a current communication state. In some embodiments, when a user device is offline, the messaging device can queue an attempted message and either discard the attempted message upon determining that transmission is not permitted or transmit the attempted message upon determining that a reset condition has occurred.

In some embodiments, the messaging device synchronizes a communication record across multiple computing devices associated with a user account. In some embodiments, synchronization includes updating a contact-position value, a timeout expiration time value, and a viewed-status value. In some embodiments, when conflicting updates occur at different devices, the messaging device resolves the conflict based on a most recent timestamp, a device having a higher priority, or a server-validated state.

In some embodiments, binary options in addition to open circles and filled circles are used. For example, a first message option can be represented as an unfilled geometric shape and a second message option can be represented as a filled version of the geometric shape. In other embodiments, more than two message options are available, and the messaging device selects a subset of the message options as the available message options set for a given communication state. In some embodiments, the messaging device provides state-dependent restrictions for the additional message options, including permitting transmission of a first message option only as an initial message and permitting transmission of a second message option only as a reply.

In some embodiments, the messaging device applies the communication-state control described herein to communications associated with different interface contexts, including a one-to-one chat, a group chat, or a chat room. In some embodiments, when the communication includes more than two participants, the messaging device maintains a communication record for each pair of participants or maintains a communication record for the communication collectively and determines transmission permissions based on participant role, message origin, and message status.

### Computer System

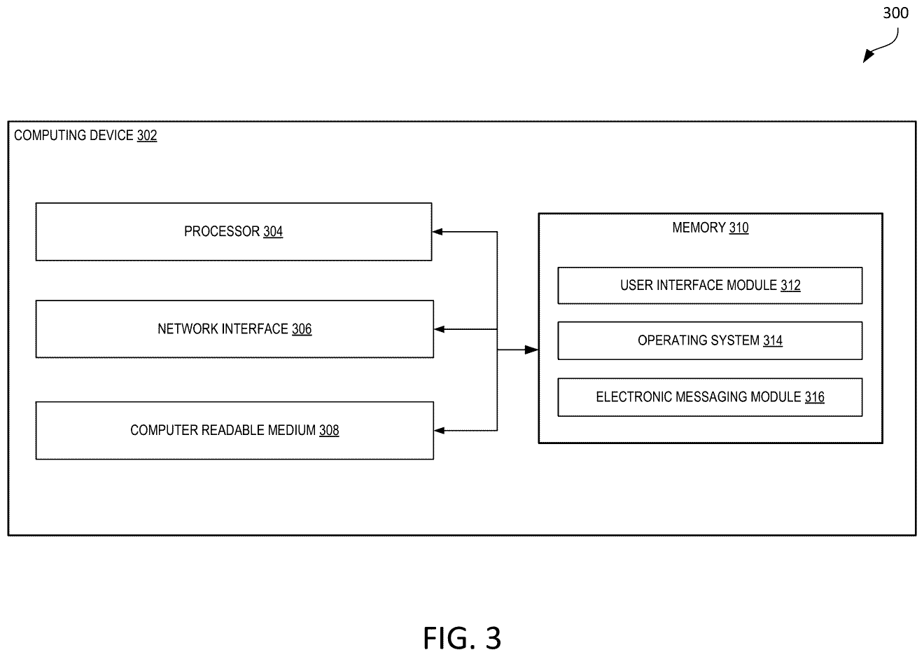

In some embodiments, the systems, processes, and methods described herein are implemented using a computing system, such as the one illustrated in FIG. 3. The example computer system 300 is in communication with one or more computing devices 302 and/or one or more data sources via one or more networks. The computing device 302 can be any computing device such as a desktop, a laptop, a mobile phone (or smartphone), a tablet, a kiosk, a television, a wristwatch (including a smartwatch), a wireless device, a media player, one or more processor devices, integrated circuit components for inclusion in computing devices, and the like. Additionally, the one or more networks may be any wired network, wireless network, or combination thereof. In addition, the one or more networks may be a personal area network, local area network, wide area network, over-the-air broadcast network, cable network, satellite network, cellular telephone network, or combinations thereof. In some embodiments, the one or more networks may be a private or semi-private network, and may include one or more wireless networks, such as a Global System for Mobile Communications (GSM) network, a Code Division Multiple Access (CDMA) network, a Long Term Evolution (LTE) network, or any other type of wireless network. The one or more networks can use protocols and components for communicating via the Internet or any of the other aforementioned types of networks.

While FIG. 3 illustrates an embodiment of a computing system 300, it is recognized that the functionality provided for in the components and modules of computer system 300 can be combined into fewer components and modules, or further separated into additional components and modules.

The computer system 300 can comprise an electronic messaging module 316 that carries out the functions, methods, acts, and/or processes described herein. The electronic messaging module 316 is executed on the computer system 300 by a processor 304 discussed further below.

In general the word “module,” as used herein, refers to logic embodied in hardware or firmware or to a collection of software instructions, having entry and exit points. Modules are written in a program language, such as JAVA, C, or C++, or the like. Software modules can be compiled or linked into an executable program, installed in a dynamic link library, or can be written in an interpreted language such as BASIC, PERL, LAU, PHP or Python and any such languages. Software modules can be called from other modules or from themselves, and/or can be invoked in response to detected events or interruptions. Modules implemented in hardware include connected logic units such as gates and flip-flops, and/or can include programmable units, such as programmable gate arrays or processors.

Generally, the modules described herein refer to logical modules that can be combined with other modules or divided into sub-modules despite their physical organization or storage. The modules are executed by one or more computing systems, and can be stored on or within any suitable computer readable medium, or implemented in-whole or in-part within special designed hardware or firmware. Not all calculations, analysis, and/or optimization require the use of computer systems, though any of the above-described methods, calculations, processes, or analyses can be facilitated through the use of computers. Further, in some embodiments, process blocks described herein can be altered, rearranged, combined, and/or omitted.

As illustrated, the computing device 302 includes a processor 304, a network interface 306, and a computer readable medium 308, all of which may communicate with one another by way of a communication bus. The network interface 306 may provide connectivity to one or more networks or computing systems. The processor 304 may thus receive information and instructions from other computing systems or services.

The processor 304 may also communicate with memory 310. The memory 310 may contain computer program instructions (grouped as modules in some embodiments) that the processor 304 executes in order to implement one or more aspects of the present disclosure. The memory 310 may include RAM, ROM, and/or other persistent, auxiliary, or non-transitory computer-readable media. The memory 310 may store an operating system 314 that provides computer program instructions for use by the processor 304 in the general administration and operation of the computing device 302. The memory 310 may further include computer program instructions and other information for implementing one or more aspects of the present disclosure. For example, in one embodiment, the memory 310 includes a user interface module 312 that generates user interfaces (and/or instructions therefor) for display upon a user computing device, e.g., via a navigation and/or browsing interface such as a browser or application installed on the user computing device. In addition, the memory 310 may include or communicate with one or more data stores.

In addition to and/or in combination with the user interface module 312, the memory 310 may include an electronic messaging module 316 that may be executed by the processor 304. In one embodiment, the electronic messaging module 316 implements various aspects of the present disclosure, e.g., those illustrated in FIGS. 1-2 or described with reference to FIGS. 1-2.

While the electronic messaging module 316 is shown in FIG. 3 as part of the computing system 300, in other embodiments, all or a portion of the electronic messaging module 316 may be implemented by other components and/or another computing device. For example, in certain embodiments of the present disclosure, another computing device may include several modules or components that operate similarly.

Although a single processor, a single network interface, a single computer readable medium, and a single memory are illustrated in the example of FIG. 3, in other implementations, the computing system 300 can have a multiple of one or more of these components (e.g., two or more processors and/or two or more memories).

Memory 310 may include random access memory (RAM) for temporary storage of information, a read only memory (ROM) for permanent storage of information, and a mass storage device, such as a backing store, hard drive, rotating magnetic disks, solid state disks (SSD), flash memory, phase-change memory (PCM), 3D XPoint memory, diskette, or optical media storage device. Alternatively, the mass storage device can be implemented in an array of servers. Typically, the components of the computer system 300 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 300 may include one or more input/output (I/O) devices and interfaces, such as a keyboard, mouse, touch pad, and printer. The I/O devices and interfaces can include one or more display devices, such as a monitor, that allows the visual presentation of data to a user. More particularly, a display device provides for the presentation of GUIs as application software data, and multi-media presentations, for example. The I/O devices and interfaces can also provide a communications interface to various external devices. The computer system can comprise one or more multi-media devices, such as speakers, video cards, graphics accelerators, and microphones, for example.

The computing system 300 illustrated in FIG. 3 may be coupled to a network, such as a LAN, WAN, or the Internet via a communication link (wired, wireless, or a combination thereof). The network communicates with various computing devices and/or other electronic devices. The network is communicating with one or more computing systems 300 and one or more data sources. The electronic messaging module 316 can access or can be accessed by computing systems 300 and/or data sources through a web-enabled user access point. Connections can be a direct physical connection, a virtual connection, and other connection type. The web-enabled user access point can comprise a browser module that uses text, graphics, audio, video, and other media to present data and to allow interaction with data via the network.

### Example Implementations (EIs)

Some enumerated example implementations (EIs) are provided in this section, without limitation.
EI 1: A messaging device comprising: a display; and an input device, the messaging device being configured to: present only an open circle and a filled circle as available message options for a communication between a sender and a recipient; arrange a contact associated with the communication in a new-message contact position ordered chronologically in response to receipt of the open circle; block transmission of the open circle by the recipient while the contact remains in the new-message contact position; permit transmission of the filled circle by the recipient as a reply to the open circle; and prevent, after the filled circle is transmitted as the reply, the sender of the open circle from transmitting either the open circle or the filled circle from the new-message contact position.
EI 2: The messaging device of EI 1, wherein, after the contact is moved from the new-message contact position to a default contact position ordered alphabetically, the messaging device permits transmission of the open circle by the recipient.
EI 3: The messaging device of EI 1, wherein, after the recipient transmits the filled circle in reply to the open circle, the messaging device prevents the recipient from transmitting the open circle for a predetermined duration in both the new-message contact position and a default contact position.
EI 4: The messaging device of EI 3, wherein, when the open circle to which the filled circle replied has become stale, the messaging device permits transmission of the open circle before expiration of the predetermined duration.
EI 5: The messaging device of EI 1, wherein, when the filled circle is the only available reply message, the messaging device is configured to transmit the filled circle in response to a single tap, a double tap, or a long press entered through the input device.
EI 6: The messaging device of EI 1, wherein the filled circle is transmittable as a stand-alone statement without a preceding open circle.
EI 7: The messaging device of EI 6, wherein, after transmission of the filled circle as the stand-alone statement, the messaging device prohibits transmission of another message for a predetermined duration.
EI 8: The messaging device of EI 1, wherein, when the recipient transmits the filled circle in reply to the open circle, the messaging device generates the filled circle by filling the open circle displayed on the display.
EI 9: The messaging device of EI 1, wherein the messaging device saves only a most recent message comprising a last received message or a last sent message for the communication.
EI 10: The messaging device of EI 1, wherein the display is configured to present, in a list of chat rooms, one of three indications corresponding respectively to no received message, a received open circle, and a received filled circle.
EI 11: A method of controlling message transmission between a sender and a recipient, the method comprising: presenting, on a messaging device, only an open circle and a filled circle as available message options; displaying a contact associated with the sender in a new-message contact position ordered chronologically after the recipient receives the open circle from the sender; blocking transmission of the open circle by the recipient while the contact remains in the new-message contact position; permitting the recipient to transmit the filled circle as a reply to the open circle; and permitting transmission of the open circle by the recipient after the contact is moved from the new-message contact position to a default contact position ordered alphabetically.
EI 12: The method of EI 11, further comprising, after the recipient transmits the filled circle in reply to the open circle, preventing the sender of the open circle from transmitting either the open circle or the filled circle from the new-message contact position.
EI 13: The method of EI 11, further comprising, after the recipient receives the filled circle, preventing the recipient from transmitting the open circle and the filled circle for a predetermined duration.
EI 14: The method of EI 13, wherein the predetermined duration is set by the sender, set by the recipient, or automatically determined based on a messaging frequency between the sender and the recipient.
EI 15: The method of EI 11, further comprising keeping displayed a selected number of messages for the sender and the recipient and, when the selected number is exceeded, replacing a message displayed first among the displayed messages with an immediately subsequent message.
EI 16: The method of EI 15, wherein replacing the message displayed first among the displayed messages with the immediately subsequent message occurs when the message displayed first among the displayed messages has not been viewed by an intended recipient.
EI 17: A non-transitory computer-readable medium storing instructions that, when executed by a messaging device having a display and an input device, cause the messaging device to: present only an open circle and a filled circle as available message options for a communication between a sender and a recipient; arrange a contact associated with the communication in a new-message contact position ordered chronologically in response to receipt of the open circle; block transmission of the open circle by the recipient while the contact remains in the new-message contact position; permit transmission of the filled circle by the recipient as a reply to the open circle; and prevent, after the filled circle is transmitted as the reply, the sender of the open circle from transmitting either the open circle or the filled circle from the new-message contact position.
EI 18: The non-transitory computer-readable medium of EI 17, wherein the instructions further cause the messaging device to display, in a list of chat rooms, one of three indications corresponding respectively to no received message, a received open circle, and a received filled circle.
EI 19: The non-transitory computer-readable medium of EI 17, wherein the instructions further cause the messaging device to save only a most recent message comprising a last received message or a last sent message for the communication.
EI 20: The non-transitory computer-readable medium of EI 17, wherein, when the filled circle is a sole available reply message, the instructions cause the messaging device to transmit the filled circle in response to a single tap, a double tap, or a long press entered through the input device.

### Other Embodiments

While operations may be depicted in the drawings or described in the specification in a particular order, such operations need not be performed in the particular order shown or in sequential order, or that all operations be performed, to achieve desirable results. In particular, elements presented relating to GUI elements or displays to a user may be presented in any particular order to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some examples, the actual steps taken in the processes illustrated and/or disclosed may differ from those shown in the figures. Depending on the example, certain of the steps described above may be removed or others may be added. Furthermore, the features and attributes of the specific examples disclosed above may be combined in different ways to form additional examples, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the features described herein can be provided separately, or integrated together (e.g., packaged together, or attached together).

For purposes of this disclosure, certain aspects, advantages, and novel features are described herein. Not necessarily all such advantages may be achieved in accordance with any particular example. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain examples include, while other examples do not include, certain features, elements, and/or steps. Thus, such conditional language is not generally intended to imply that features, elements, and/or steps are in any way required for one or more examples or that one or more examples necessarily include logic for deciding, with or without user input or prompting, whether these features, elements, and/or steps are included or are to be performed in any particular example.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

Language of degree used herein, such as the terms “approximately,” “about,” “generally,” and “substantially” represent a value, amount, or characteristic close to the stated value, amount, or characteristic that still performs a desired function or achieves a desired result.

The scope of the present disclosure is not intended to be limited by the specific disclosures of preferred examples in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Although the foregoing invention has been described in terms of certain preferred embodiments, other embodiments will be apparent to those of ordinary skill in the art. Additionally, other combinations, omissions, substitutions and modification will be apparent to the skilled artisan, in view of the disclosure herein. Accordingly, the present invention is not intended to be limited by the recitation of the preferred embodiments, but is instead to be defined by reference to the appended claims. All references cited herein are incorporated by reference in their entirety.

The terminology used in the description presented herein is not intended to be interpreted in any limited or restrictive manner and unless otherwise indicated refers to the ordinary meaning as would be understood by one of ordinary skill in the art in view of the specification. Furthermore, embodiments may comprise, consist of, consist essentially of, several novel features, no single one of which is solely responsible for its desirable attributes or is believed to be essential to practicing the embodiments herein described. As used herein, the section headings are for organizational purposes only and are not to be construed as limiting the described subject matter in any way. All literature and similar materials cited in this application, including but not limited to, patents, patent applications, articles, books, treatises, and internet web pages are expressly incorporated by reference in their entirety for any purpose. When definitions of terms in incorporated references appear to differ from the definitions provided in the present teachings, the definition provided in the present teachings shall control. It will be appreciated that there is an implied “about” prior to the temperatures, concentrations, times, etc. discussed in the present teachings, such that slight and insubstantial deviations are within the scope of the present teachings herein.

Although this disclosure is in the context of certain embodiments and examples, those of ordinary skill in the art will understand that the present disclosure extends beyond the specifically disclosed embodiments to other alternative embodiments and/or uses of the embodiments and obvious modifications and equivalents thereof. In addition, while several variations of the embodiments have been shown and described in detail, other modifications, which are within the scope of this disclosure, will be readily apparent to those of ordinary skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes or embodiments of the disclosure. Thus, it is intended that the scope of the present disclosure herein disclosed should not be limited by the particular disclosed embodiments described above.

What is claimed is:

1. A messaging device comprising:
a display; and
an input device,
the messaging device being configured to:
present only an open circle and a filled circle as available message options for a communication between a sender and a recipient;
arrange a contact associated with the communication in a new-message contact position ordered chronologically in response to receipt of the open circle;
block transmission of the open circle by the recipient while the contact remains in the new-message contact position;
permit transmission of the filled circle by the recipient as a reply to the open circle; and
prevent, after the filled circle is transmitted as the reply, the sender of the open circle from transmitting either the open circle or the filled circle from the new-message contact position.

2. The messaging device of claim 1, wherein, after the contact is moved from the new-message contact position to a default contact position ordered alphabetically, the messaging device permits transmission of the open circle by the recipient.

3. The messaging device of claim 1, wherein, after the recipient transmits the filled circle in reply to the open circle, the messaging device prevents the recipient from transmitting the open circle for a predetermined duration in both the new-message contact position and a default contact position.

4. The messaging device of claim 3, wherein, when the open circle to which the filled circle replied has become stale, the messaging device permits transmission of the open circle before expiration of the predetermined duration.

5. The messaging device of claim 1, wherein, when the filled circle is the only available reply message, the messaging device is configured to transmit the filled circle in response to a single tap, a double tap, or a long press entered through the input device.

6. The messaging device of claim 1, wherein the filled circle is transmittable as a stand-alone statement without a preceding open circle.

7. The messaging device of claim 6, wherein, after transmission of the filled circle as the stand-alone statement, the messaging device prohibits transmission of another message for a predetermined duration.

8. The messaging device of claim 1, wherein, when the recipient transmits the filled circle in reply to the open circle, the messaging device generates the filled circle by filling the open circle displayed on the display.

9. The messaging device of claim 1, wherein the messaging device saves only a most recent message comprising a last received message or a last sent message for the communication.

10. The messaging device of claim 1, wherein the display is configured to present, in a list of chat rooms, one of three indications corresponding respectively to no received message, a received open circle, and a received filled circle.

11. A method of controlling message transmission between a sender and a recipient, the method comprising:
presenting, on a messaging device, only an open circle and a filled circle as available message options;
displaying a contact associated with the sender in a new-message contact position ordered chronologically after the recipient receives the open circle from the sender;
blocking transmission of the open circle by the recipient while the contact remains in the new-message contact position;
permitting the recipient to transmit the filled circle as a reply to the open circle; and
permitting transmission of the open circle by the recipient after the contact is moved from the new-message contact position to a default contact position ordered alphabetically.

12. The method of claim 11, further comprising, after the recipient transmits the filled circle in reply to the open circle, preventing the sender of the open circle from transmitting either the open circle or the filled circle from the new-message contact position.

13. The method of claim 11, further comprising, after the recipient receives the filled circle, preventing the recipient from transmitting the open circle and the filled circle for a predetermined duration.

14. The method of claim 13, wherein the predetermined duration is set by the sender, set by the recipient, or automatically determined based on a messaging frequency between the sender and the recipient.

15. The method of claim 11, further comprising keeping displayed a selected number of messages for the sender and the recipient and, when the selected number is exceeded, replacing a message displayed first among the displayed messages with an immediately subsequent message.

16. The method of claim 15, wherein replacing the message displayed first among the displayed messages with the immediately subsequent message occurs when the message displayed first among the displayed messages has not been viewed by an intended recipient.

17. A non-transitory computer-readable medium storing instructions that, when executed by a messaging device having a display and an input device, cause the messaging device to:
present only an open circle and a filled circle as available message options for a communication between a sender and a recipient;
arrange a contact associated with the communication in a new-message contact position ordered chronologically in response to receipt of the open circle;
block transmission of the open circle by the recipient while the contact remains in the new-message contact position;
permit transmission of the filled circle by the recipient as a reply to the open circle; and
prevent, after the filled circle is transmitted as the reply, the sender of the open circle from transmitting either the open circle or the filled circle from the new-message contact position.

18. The non-transitory computer-readable medium of claim 17, wherein the instructions further cause the messaging device to display, in a list of chat rooms, one of three indications corresponding respectively to no received message, a received open circle, and a received filled circle.

19. The non-transitory computer-readable medium of claim 17, wherein the instructions further cause the messaging device to save only a most recent message comprising a last received message or a last sent message for the communication.

20. The non-transitory computer-readable medium of claim 17, wherein, when the filled circle is a sole available reply message, the instructions cause the messaging device to transmit the filled circle in response to a single tap, a double tap, or a long press entered through the input device.
